(19) United States
(12) Patent Application Publication
(10) Pub. No.: US 2026/0023878 A1
(43) Pub. Date: Jan. 22, 2026

(54) USER MANAGEMENT SYSTEM

(71) Applicant: TOYOTA JIDOSHA KABUSHIKI KAISHA, Aichi-ken (JP)

(72) Inventor: Pritish DEBASIS, Tokyo-to (JP)

(21) Appl. No.: 19/250,076

(22) Filed: Jun. 26, 2025

(30) Foreign Application Priority Data
Jul. 22, 2024 (JP) 2024-117149

(51) Int. Cl. G06F 21/62; H04W 4/38

(52) U.S. Cl. CPC G06F 21/6254; H04W 4/38

(57) ABSTRACT

A user management system manages users who use first to N-th rooms. The system is configured to execute a user detection process to detect a user who is present in an i-th room without identifying the user. The system is configured to set an anonymous flag to a first user detected by the user detection process. The system is configured to determine whether the first user takes a first specific action in a j-th room, the first specific action being associated with the first user. The system is configured to set a first specific flag for identifying the first user to the first user when the first user takes the first specific action.

### CROSS REFERENCE TO RELATED APPLICATION

This application claims priority to Japanese Patent Application No. 2024-117149 filed on Jul. 22, 2024, the entire contents of which are incorporated by reference herein.

### TECHNICAL FIELD

The present disclosure relates to a user management system for managing users who use one or more rooms.

### BACKGROUND ART

Patent Literature 1 discloses a behavior recognition system that can detect, identify, and specify behavior information of residents in a living space. The behavior recognition system includes a human detection sensor that detects the presence of a person, and a human recognition sensor that acquires information for identifying the detected person. The behavior recognition system estimates human behavior based on information acquired by the human detection sensor and the human recognition sensor.

### LIST OF RELATED ART

Patent Literature 1: Japanese Patent Application Publication No. 2024-011411

Managing users who use a room is considered. In order to understand user behavior in detail and realize detailed user management, it is necessary to identify the user. However, constantly monitoring the user with a camera etc. for this purpose is not desirable from the viewpoint of protecting the user's privacy.

One purpose of the present disclosure is to provide a technique that enables detailed user management while taking into account privacy protection.

The first aspect relates to a user management system for managing one or more users who use first to N-th rooms (N is an integer of one or more). The user management system comprising processing circuitry configured to:
execute a user detection process to detect a user who is present in an i-th room (i=any of 1 to N) without identifying the user;
set an anonymous flag to a first user detected by the user detection process;
determine whether the first user, to whom the anonymous flag is set, takes a first specific action in a j-th room (j=any of 1 to N), the first specific action being associated with the first user; and
set a first specific flag for identifying the first user to the first user when the first user, to whom the anonymous flag is set, takes the first specific action.

The user management system selectively uses a “user detection process” that detects a user without identifying the user, and a “user identification process” that identifies a user based on the specific action performed by the user. Furthermore, since the specific action that triggers the process is a voluntary action of the user, management that takes privacy into consideration can be realized even if a device to identify individuals is installed in each room. In other words, the user management system can realize detailed user management that takes into account privacy protection.

### BRIEF DESCRIPTION OF DRAWINGS

FIG. 1 is a schematic diagram showing an overview of a user management system;

FIG. 2 is a flowchart showing the flow of process in the user management system;

FIG. 3 is a schematic diagram showing some examples of a re-anonymization process;

FIG. 4 is a schematic diagram showing an overview of a movement determination process;

FIG. 5 is a schematic diagram showing an example of an indirect user identification process;

FIG. 6 is a block diagram showing an example of a configuration of the user management system.

### DETAILED DESCRIPTION

Embodiments of the present disclosure will be described with reference to the drawings.

### 1. User Management System

### 1-1. Main Components

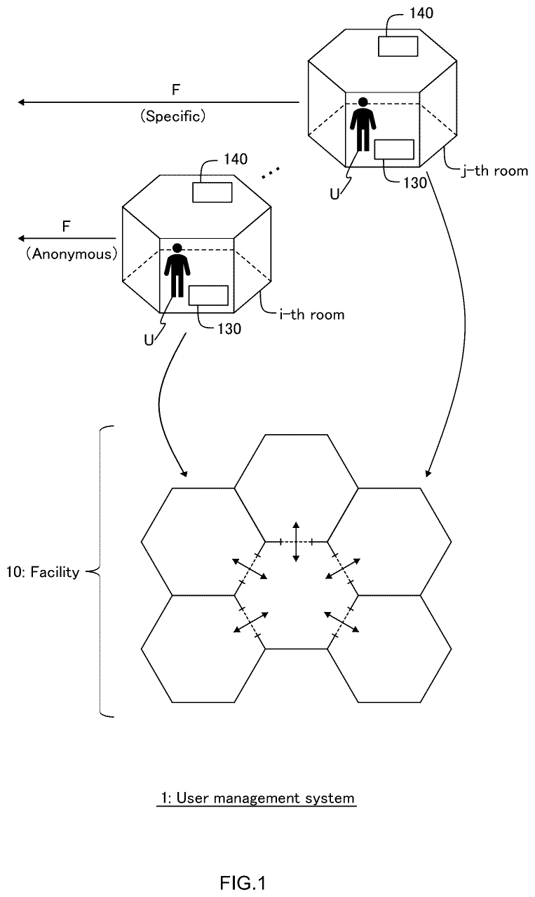

FIG. 1 is a schematic diagram showing an overview of a user management system 1. The user management system 1 manages one or more users (hereinafter referred to as “user U”) who use first to N-th rooms (N is an integer of 1 or more). The first to N-th rooms are configured so that they can be accessed via a passageway or other rooms. The user management system 1 is typically applied to a space that is formed of a plurality of private rooms and is used by a plurality of specific people, such as an apartment building, an office, etc.

Each of the first to N-th rooms is equipped with a user detection unit 130 and a user identification unit 140.

The user management system 1 executes a “user detection process” to detect the user U present in a room in which the user detection unit 130 is installed. The user detection process is merely a process for detecting the presence of a person (user U), and does not identify who the detected person is. The user management system 1 sets an “anonymous flag” to a user detected by the user detection process. The user detection unit 130 includes, for example, a human detection sensor such as an infrared sensor or a wireless sensing device. Wireless sensing is a mechanism for detecting objects by detecting fluctuations in radio waves that occur when wireless communication radio waves are blocked by an object. In this embodiment, for ease of explanation, a user detected by the user detection process in an i-th room (i=1 to N) is defined as a “first user U-1.” That is, the user detection process is a process of detecting the first user U-1 present in the i-th room and setting an anonymous flag to the first user U-1.

The user management system 1 determines whether the first user U-1, to whom the anonymous flag is set, has performed a “specific action.” The specific action is an action for identifying each user U, and is an action that the user U performs voluntarily and independently. Examples of specific actions include physical actions (sitting in a specific place, raising both hands, etc.) and device operations such as turning on a specific electronic device (e.g., a PC) or logging into a specific system using electronic devices. When a specific action by a first user U-1 is detected, the user management system 1 identifies who the user is by setting a “first specific flag” to the first user U-1 to which an anonymous flag has been set. Hereinafter, the process of identifying the user U by setting the identification flag will be referred to as a “user identification process.” It is assumed that a first user U-1 performs the first specific action in a j-th room (j=any of 1 to N) and is identified by the user identification process.

When detecting a physical action in the user identification process, the user identification unit 140 includes an image capturing device such as a camera. Since the image capturing device captures images of each room, constant use of the device to identify the first user U-1 is not preferable from the viewpoint of privacy protection. However, the user identification process by the user management system 1 is initiated by a trigger that is an action that the first user U-1 performs on his/her own initiative, that is, an action that is performed with understanding that he/she will be identified. It can be said that the user identification process in the user management system 1 makes it possible to simultaneously identify individuals present in each room and protect their privacy.

The user detection process and the user identification process may be performed in the same room or in different rooms. In other words, the user U detected by the user detection process may move to another room and be identified by performing a specific action in the new room.

The user management system 1 acquires information on the anonymous flag and the specific flag as flag information F. The user management system 1 collectively manages the received flag information F. Specifically, the user management system 1 manages the number of users U present in each room and situations of entering and leaving each room of the users U based on the flag information F.

In this embodiment, a case will be taken up where the user management system 1 is applied to a facility 10 as shown in the lower part of FIG. 1 The facility 10 is formed by multiple hexagonal shaped rooms, with the central room being accessible to all the other rooms. In other words, the rooms in the facility 10 are configured to be accessible from one another via a central room. It should be noted that the facility 10 is merely an example to which the user management system 1 is applied, and the number, shape, arrangement, etc. of rooms are not limited to the example shown in this embodiment.

### 1-2. Process Flow

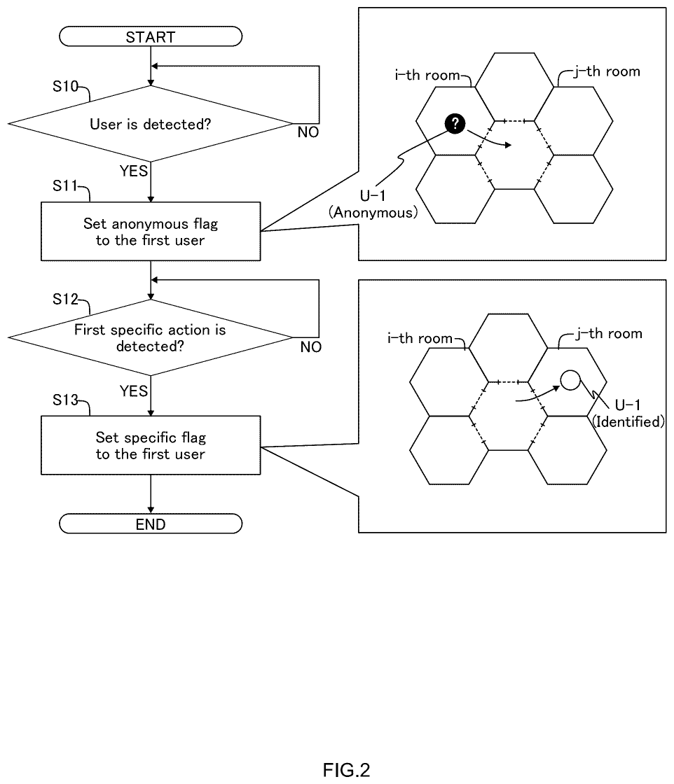

FIG. 2 is a flowchart showing the flow of process in the user management system 1. The right part of the figure shows a schematic diagram of the state of the facility 10 in a series of steps.

In step S10, the user management system 1 executes the user detection process in the i-th room. If a user is detected (S10; Yes), the process proceeds to step S11. If no user is detected (S10; No), the process repeats step S10.

In step S11, the user management system 1 sets an anonymous flag to the first user U-1 detected in the i-th room. At this point, the user detection unit 130 recognizes that the first user U-1 is present in the i-th room, but has not yet specifically identified who the first user U-1 is. The process then proceeds to step S12.

In step S12, the user management system 1 determines whether or not the first specific action has been performed in the j-th room. If the first specific action has been performed (S12; Yes), the process proceeds to step S13. When the first specific action is not performed (S12; No), the process repeats step S12.

In step S13, the user management system 1 sets the first specific flag to the first user U-1. At this point, the user identification unit 140 can identify who the first user U-1 detected in the i-th room is. The process then terminates.

### <Effects>

The user management system 1 selectively uses the “user detection process” that detects the user U without identifying the user U, and the “user identification process” that identifies the user U based on the specific action performed by the user U. Furthermore, since the specific action that triggers the process is an action initiated by the user U independently, management with taking privacy into consideration can be realized even if a device for identifying individuals is installed in each room. In other words, the user management system 1 can realize detailed user management that takes into account privacy protection.

### 2. Other Process

### 2-1. Re-Anonymization Process

Consider the case where there is a plurality of users U. In this case, if there are multiple users U-1 to M (M is an integer of 2 or more) in the k-th room (k=1 to N), including a first user U-1, to whom a first specific flag has been set, it is desirable to update the first specific flag set to the first user U-1 to an anonymous flag. Hereinafter, the process of updating the specific flag to an anonymous flag will be referred to as a “re-anonymization process.”

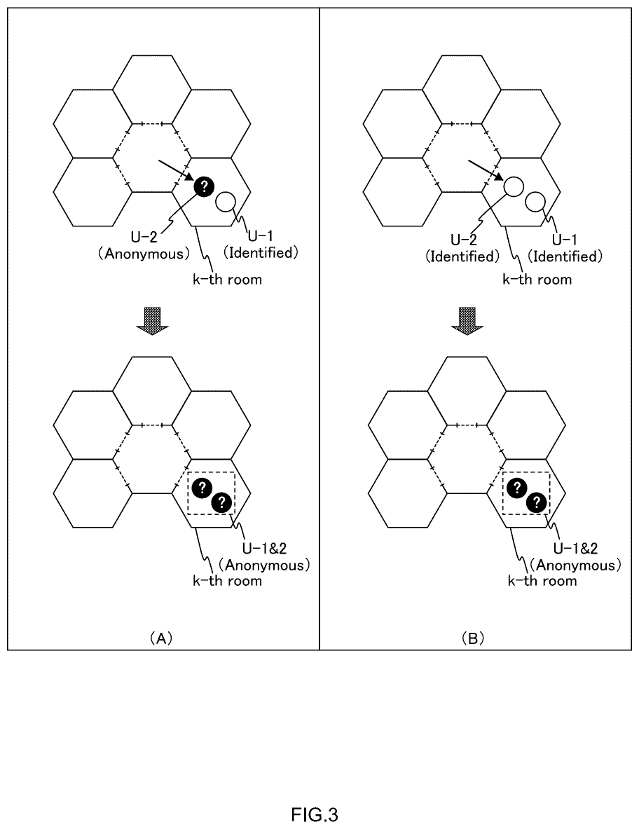

FIG. 3 is a schematic diagram showing some examples of the re-anonymization process. Part (A) of FIG. 3 shows a situation in which a second user U-2, to which an anonymity flag has been set, enters the k-th room where the first user U-1 is present. Since the user management system I manages the users U based on the number of flags in each room, if there are two users in the k-th room, it is not possible to identify which one is the identified first user U-1. Therefore, in such a case, it is desirable to update the first specific flag of the first user U-1 to an anonymous flag so that two anonymous users exist in the k-th room. The re-anonymization process prevents erroneous correspondence between two types of flags (anonymous flags and specific flags). As shown in part (B) of FIG. 3, when a second user U-2 to which a second specific flag has been set enters the k-th room, re-anonymization process is performed not only on the first user U-1 but also on the second user U-2.

### 2-2. Movement Determination Process

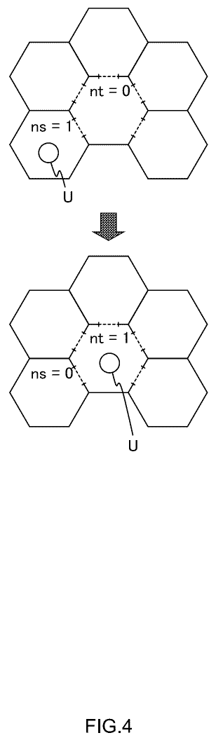

Consider a case where the first to N-th rooms include two adjacent rooms. The user management system 1 may execute a “movement determination process” to determine whether or not a user present in one of two adjacent rooms has moved to the other of the two adjacent rooms. FIG. 4 is a schematic diagram showing an overview of the movement determination process. If the two adjacent rooms are referred to a s-th room and t-th room (s, t=1 to N), the movement determination process can be said to be a process of determining whether or not user U has moved between the s-th room and the t-th room. The movement determination process is executed based on the s-th user number ns and the t-th user number nt. The s-th user number ns indicates the number of users present in the s-th room. In other words, the s-th user number ns can be said to be the number of flags in the s-th room (the total of anonymous flags and specific flags). Similarly, the t-th user number nt indicates the number of users present in the t-th room. In the example of FIG. 4, the user U moves from the s-th room to the t-th room. When user U is present in the s-th room, the s-th user number ns is I and the t-th user number nt is 0. When the user U moves to the t-th room, the s-th user number ns is 0 and the t-th user number nt is 1. Since the s-th room and the t-th room are adjacent to each other, the change in the s-th user number ns and the t-th user number nt accompanying the movement of user U should occur within a short period of time. Generally speaking, if both the s-th user number ns and the t-th user number nt change within a preset period of time, the user management system 1 determines that the user U has moved between the s-th room and the t-th room.

The s-th user number ns and the t-th user number nt can be said to be adjacent user number information. In other words, the movement determination process is a process that determines, based on the adjacent user number information, whether the user U present in one of two adjacent rooms has moved to the other of the two adjacent rooms. In other words, by repeating the movement determination process, the user management system 1 can track the user U within the facility 10.

### 2-3. Indirect User Identification Process

In addition to the method based on the specific action as described in Section 1-1, a method of indirectly identifying the first user U-1 is also possible in the user identification process. Such a process is specifically referred to as an “indirect user identification process.”

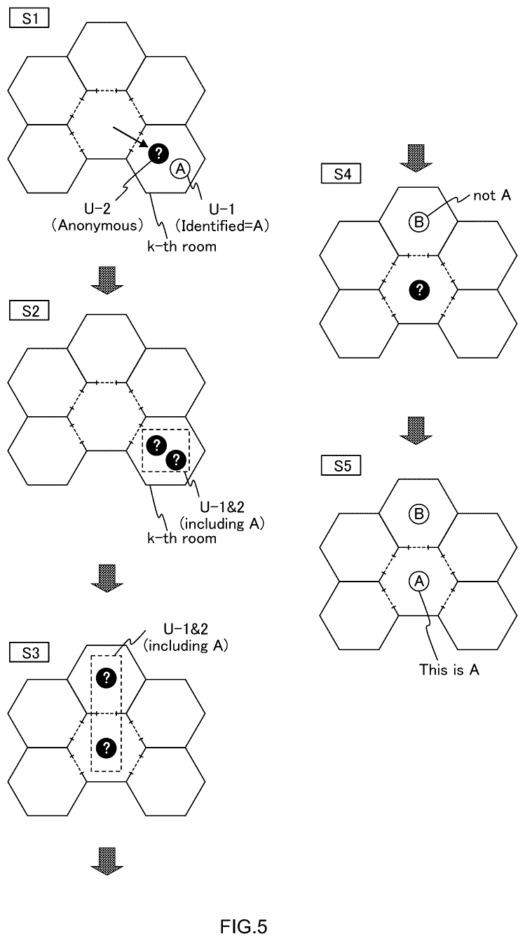

FIG. 5 is a schematic diagram showing an example of the indirect user identification process. S1 and S2 are in the same situation as part (A) of FIG. 3. In S1, it is assumed that the first user U-1 is associated with a user ID “A” corresponding to the first specific flag.

In S2, the re-anonymization process is executed, and the first user U-1 and the second user U-2 are recognized by the user management system 1 as two anonymous users. At this time, the user management system 1 records that “A” is included among the two anonymous users.

Thereafter, the two anonymous users including “A” each move and reach the state of S3. At this time, if the movement determination process has been executed, the user management system 1 can track two anonymous users including “A”. However, it is not possible to determine which of the two anonymous users is “A.”

In S4, it is assumed that one of the two anonymous users is identified as “B” (i.e., not “A”) through the user identification process. In this case, since the other of the two anonymous users (the one other than “B”) is uniquely determined to be “A,” the user management system 1 can indirectly identify “A.” At this time, the user management system 1 can identify “A” without determining the first specific action. Since “A” has already been identified by performing an identifying action, this process is not problematic from the viewpoint of privacy protection even if “A” is identified again.

The indirect user identification process is applicable not only to the case where there are two anonymous users, but also to the general case where there are multiple anonymous users. Generally speaking, the indirect user identification process is applied when the second to M-th specific flags are set to all of the second to M-th users after an anonymous flag is set to the first user U-1 through the re-anonymization process in the k-th room.

### 3. Configuration Example

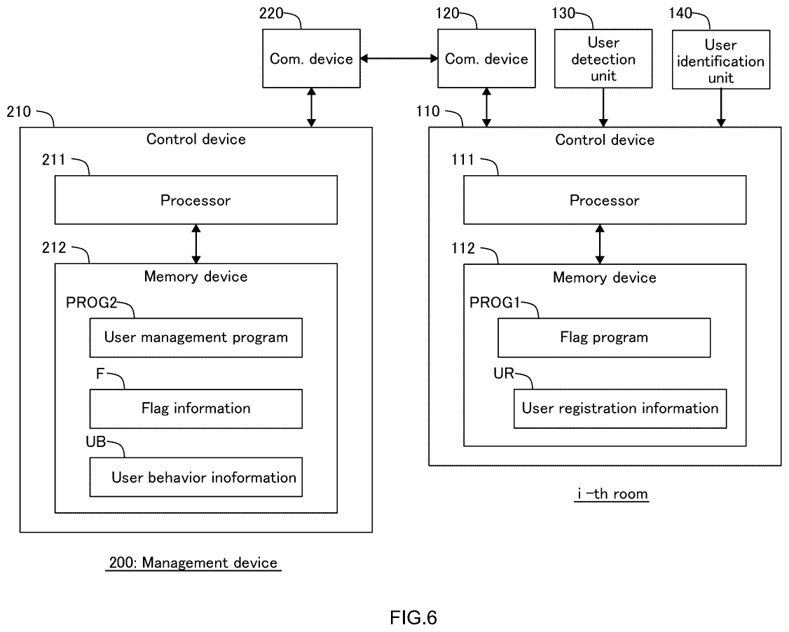

FIG. 6 is a block diagram showing an example of a configuration of the user management system 1.

3-1. Example of the i-th Room Configuration

The right side of FIG. 6 shows an example of the configuration of the i-th room. Since the first to Nth rooms have the common configuration, the i-th room is shown here as a representative.

The control device 110 is a computer that controls each device installed in the i-th room. The control device 110 includes one or more processors 111 (hereinafter simply referred to as processor 111) and one or more memory devices 112 (hereinafter simply referred to as memory device 112). The processor 111 executes various processes. For example, the processor 111 includes a central processing unit (CPU). The processor 111 may also be referred to as a processing circuitry. The memory device 112 stores various types of information. Examples of the memory device 112 include a volatile memory, a non-volatile memory, a hard disk drive (HDD), a solid-state drive (SSD), etc.

The flag program PROG1 is a computer program executed by the processor 111. The functions of the control device 110 are realized by cooperation between the processor 111 that executes a flag program PROG1 and the memory device 112. For example, the above-mentioned user detection process and user identification process are performed by the control device 110 executing the flag program PROG1. The flag program PROG1 is stored in the memory device 112. Alternatively, the flag program PROG1 may be recorded in a computer-readable recording medium.

The control device 110 executes the user detection process and the user identification process. The control device 110 obtains information required for user detection process via the user detection unit 130, and obtains information required for user identification process via the user identification unit 140. In addition, the control device 110 communicates with a management device 200 via a communication device 120. The control device 110 transmits the results of the user detection process and the user identification process, that is, flag information F, to the management device 200.

The user registration information UR is information necessary for the user identification process. The user registration information UR has a format in which the user ID of each user U is associated with data on the specific action corresponding to the user ID.

### 3-2. Example Configuration of Management Device

The control device 210 is a computer that controls the management device 200. The control device 210 includes one or more processors 211 (hereinafter simply referred to as processor 211) and one or more memory devices 212 (hereinafter simply referred to as memory device 212). The processor 211 executes various processes. For example, the processor 211 includes a central processing unit (CPU). The processor 211 may also be referred to as processing circuitry. The memory device 212 stores various types of information. Examples of the memory device 212 include a volatile memory, a non-volatile memory, a hard disk drive (HDD), a solid-state drive (SSD), etc.

The user management program PROG2 is a computer program executed by the processor 211. The processor 211 that executes the user management program PROG2 cooperates with the memory device 212 to realize the functions of the control device 210. The user management program PROG2 is stored in the memory device 212. Alternatively, the user management program PROG2 may be recorded in a computer-readable recording medium.

The flag information F is information regarding the anonymous flag and the specific flag of each room. The flag information F includes information on when, in which room, and what type of flag was set. Based on the flag information F, the management device 200 can grasp the number of users U present in each room, the period of time when users U are likely to gather, etc. The flag information F is used as the adjacent user number information in the movement determination process.

The user behavior information UB is information indicating the history of the user U's behavior. The user behavior information UB is obtained by aggregating the flag information F and the results of the movement determination process. The user behavior information UB is used to analyze the movement of the user U within the facility 10.

The control device 210 communicates with the communication device 120 in the i-th room via the communication device 220.

### 3-3. Other

The management device 200 may execute at least a part of the user detection process or the user identification process. For example, when information acquired by the user detection unit 130 and the user identification unit 140 is transmitted from the control device 110 to the management device 200, the management device 200 can execute at least a part of the user detection process and the user identification process.

In general, one or more processors perform the user detection process, the user identification process, the movement determination process, the re-anonymization process, and the indirect user identification process.

What is claimed is:

1. A user management system for managing one or more users who use first to N-th rooms (N is an integer of one or more), the user management system comprising processing circuitry configured to:
execute a user detection process to detect a user who is present in an i-th room (i=any of 1 to N) without identifying the user;
set an anonymous flag to a first user detected by the user detection process;
determine whether the first user, to whom the anonymous flag is set, takes a first specific action in a j-th room (j=any of 1 to N), the first specific action being associated with the first user; and
set a first specific flag for identifying the first user to the first user when the first user, to whom the anonymous flag is set, takes the first specific action.

2. The user management system according to claim 1, wherein
the one or more users include a plurality of users; and
the processing circuitry is further configured to update the first specific flag set to the first user to the anonymous flag, when presence of the first user, to whom the first specific flag is set, in a k-th room (k=any of 1 to N) and presence of second to M-th users (M is an integer of two or more) in the k-th room are detected by the user detection process.

3. The user management system according to claim 2, wherein
when second to M-th specific flags for identifying the second to M-th users are set to the second to M-th users, the processing circuitry is further configured to update each of the second to M-th specific flags set to the M-th users to the anonymous flag.

4. The user management system according to claim 2, wherein
when the second to M-th specific flags are set to all of the second to M-th users after the anonymous flag is set to the first user in the k-th room, the processing circuitry is configured to set the first specific flag to the first user without determining the first specific action.

5. The user management system according to claim 1, wherein
the N is two or more,
the first to N-th rooms include two adjacent rooms,
adjacent user number information is information which includes a number of users detected by the user detection process in each of the two adjacent rooms, and
the processing circuitry is further configured to execute a movement determination process based on the adjacent user number information, wherein the movement determination process determines whether a user who is present in one of the two adjacent rooms has moved to the other of the two adjacent rooms.
